(19) United States
(12) Patent Application Publication
(10) Pub. No.: US 2009/0179936 A1
(43) Pub. Date: Jul. 16, 2009

(54) LIQUID EJECTION CONTROL DEVICE, METHOD, AND PROGRAM

(75) Inventor: Kenji OTOKITA, Suwa-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/351,334

(22) Filed: Jan. 9, 2009

(30) Foreign Application Priority Data
Jan. 10, 2008 (JP) 2008-003572
Nov. 14, 2008 (JP) 2008-292656

(51) Int. Cl. B41J 2/205

(52) U.S. Cl. 347/15

(57) ABSTRACT

A liquid ejection control device, which makes an ejection object medium and an ejection nozzle column which ejects liquid relatively scan in a primary scan direction which almost perpendicularly intersects the nozzle ejection column and makes the ejection object medium and the ejection nozzle column relatively scan in a subordinate scan direction which almost perpendicularly intersects the primary scan direction. The liquid ejection control device includes an ejection control unit controlling ejections of ejection nozzles such that ejection rates of the ejection nozzles vary according to positions of the ejection nozzles in the subordinate scan direction, the variation being set such that the ejection nozzles having a maximum ejection rate are dispersed in the subordinate scan direction, when a rate of an ejection, which is charged by a predetermined ejection nozzle, to a primary scan line at the same position in the subordinate scan direction is called an ejection rate.

### BACKGROUND

1. Technical Field

The present invention relates to a liquid ejection control device, method, and program which makes an ejection object medium and an ejection nozzle column, which ejects liquid, relatively primarily scan in a primary scan direction which almost perpendicularly intersects the ejection nozzle column, and makes the ejection object medium and the ejection nozzle column relatively subordinately scan in a subordinate scan direction which almost perpendicularly intersects the primary scan direction.

2. Related Art

JP-A-2002-11859 discloses an overlap-type liquid ejection method in which a raster line is formed by performing a plural number of times of primary scan operations with respect to a raster line on the ejection object medium. With such an overlap-type liquid ejection method, it is possible to suppress influence attributable to variance of primary scan operations, and therefore it is possible to obtain the print result with good image quality.

When a liquid ejection is performed by the overlap-type liquid ejection method using a multi-type nozzle print head, a plurality of ejection nozzles ejects liquid to the same raster line on print paper. For this instance, in the case in which some ejection nozzles have a trouble with liquid ejection with respect to the raster line, such a trouble influences formation of the raster line. The overlap-type liquid ejection method is advantageous in that it is possible to reduce the influence attributable to the trouble of an ejection nozzle in comparison with a non-overlap-type liquid ejection performed using a single ejection nozzle which is troublesome but is disadvantageous in that it enhances on the contrary influence attributable to the trouble of the ejection nozzle in the case in which ejection amount of the troublesome ejection nozzle is larger than that of normal ejection nozzles.

### SUMMARY

It is an object of some aspects of the invention is to provide a printer which can suppress negative influence of a certain troublesome ejection nozzle. The subject matter of the invention is not limited to the printer which discharges ink droplets but includes a general liquid ejection control device which discharges liquid, a liquid ejection control method, and a liquid ejection control program. Accordingly the invention provides a general liquid ejection control device, method, and program.

According to one aspect of the invention, there is provided a multi-nozzle-type liquid ejection control device which makes an ejection object medium and an ejection nozzle column which ejects liquid relatively scan in a primary scan direction which almost perpendicularly intersects the ejection nozzle column and makes the ejection object medium and the ejection nozzle column relatively scan in a subordinate scan direction which almost perpendicularly intersects the primary scan direction, in which an ejection rate is controlled in a manner such that when liquid is ejected from a plurality of ejection nozzles for a primary scan line at the same position in the subordinate scan direction, ejection rates of the ejection nozzles in each of primary scans vary according to positions in the subordinate scan direction and the variation is set in a manner such that the ejection nozzles, of which the ejection rates are a maximum value, are dispersed in the subordinate scan direction. In the case in which the ejection nozzle having a maximum the ejection rate is troublesome, such a trouble negatively influences the overall ejection result even in an overlap-type print. On the contrary, according to this aspect, since the ejection nozzles having the maximum ejection rate are dispersed in the subordinate scan direction, it is possible to reduce the negative influence attributable to the event that the some ejection nozzles in the subordinate scan direction are troublesome. That is, there is a little chance that the defective nozzles exist all over a plurality of areas in the subordinate scan direction. Since ejection nozzles having the maximum ejection rate are dispersed, it is possible to enable normal ejection nozzles having the maximum ejection rate to eject liquid. The primary scan direction and the subordinate scan direction do not need to be substantially perpendicular to each other but may be sufficient that they intersect each other at an angle of around 90°. In the phrase “primary scan line at the same position in the subordinate scan direction,” the same position means an intended same position. For example, a position in a range including interlaced offset amount or mechanical precision error in from an intended same position can be called the same position.

In more detail, with the provision of two or more maximum ejection nozzle groups in each of which the ejection nozzles having the uniform and maximum ejection rate are consecutive in the subordinate scan direction, it is possible to disperse the ejection nozzles having the maximum ejection rate. It is natural that the number of ejection nozzle groups be three or more. Further, in the case in which two or more ejection nozzles groups in each of which the ejection nozzles having the uniform and maximum ejection rate are consecutive in the subordinate scan direction are provided, a low ejection rate nozzle group in which ejection rates of the ejection nozzle are low and which is shut in by the nozzle groups of the ejection head may be disposed at a midway position in the subordinate scan direction. That is, the ejection nozzle groups in which the ejection nozzles have the maximum and uniform ejection rate exist so as to shut in the midway position of the ejection head in the subordinate scan direction. With this structure, it is possible to reduce the negative influence attributable to the trouble of a middle portion of the ejection head unit in the subordinate scan direction.

It is preferable that, in the case in which there are two or more ejection nozzle groups in each of which ejection nozzles having the uniform and maximum ejection rate are consecutive in the subordinate scan direction, a low ejection rate nozzle group in which ejection nozzles have a low ejection rate and which is shut in by the ejection nozzle groups include an ejection nozzle having poor stability in ejection characteristics. With such a structure, it is possible to reduce the negative influence attributable to the ejection nozzle having poor stability in the ejection characteristics. In the variation of the ejection rates according the positions in the subordinate scan direction, there may be an area where the ejection rates vary in a nonlinear way. That is, since the ejection rates in each of the primary scans vary in the nonlinear way, it is possible to adjust the variation of the ejection rates according to the characteristics of the liquid and the ejection object medium.

In addition, since the low ejection rate nozzle group which is shut in by the ejection nozzle groups which have the maximum and uniform ejection rate includes the ejection nozzle having the poor stability in the ejection characteristic, the ejection characteristics of all of the ejection nozzles need to be obtained beforehand. Accordingly, the characteristic information in which the ejection characteristics of the ejection nozzles are contained is stored in association with the ejection heads, and the control of the ejection rate may be performed according to the characteristic information. Since the characteristic information is different for each of the ejection heads, the characteristic information must be stored in association with each of the ejection heads.

Further, the control may be performed in a manner such that the ejection rates vary according to kinds of liquid ejected from the ejection nozzles. Since the ejection characteristics are different according to kinds of liquid, it is preferable that the control of the ejection rate which is proper for the kind of liquid be performed. In more detail, in the case in which liquid which needs a relatively longer fixing when it is fixed on the ejection object medium in comparison with other liquids is ejected from the ejection nozzles, of each of primary scans with respect to the primary scan line at the same position in the subordinate scan direction, it is desirable that the ejection rate of the liquid in an initial primary scan be set higher than that of other liquids. Since it is possible to eject and fix the liquid which needs a relatively longer fixing time on the ejection object medium at a large amount at an initial stage, it is possible to suppress the problem, such as oozing and unevenness. Typically, since there is tendency that as the concentration of the liquid becomes lower, the fixing time becomes longer, the ejection rate in each of the primary scans at the initial stage may be adjusted according to the concentration.

In particular, in the case in which a pair of liquids having the same mixture materials of different concentrations is ejected from the ejection nozzle column, the ejection rate of a liquid having a lower concentration of the pair of liquids in the initial primary scan of the primary scans with respect to the primary scan line at the same position in the subordinate scan direction may be higher than that of the other liquid. With this control, it is possible to eject and fix the liquid which needs the longer fixing time on the ejection object medium at the large amount at the initial stage. In the case in which a first liquid and a second liquid, of which the ejection amounts are larger than other liquids, are ejected from the ejection nozzle column, it is preferable that the ejection rate of the first liquid in the initial primary scan of all of the primary scan for the primary scan line at the same position in the subordinate scan direction be higher than that of the second liquid. Further, since the variations of the ejection rates of the pair of liquids are symmetric, it is possible to prevent the ejection rates of the liquid from becoming higher in the initial primary scan of all of the primary scans. With this control, it is possible to reduce the total ejection amount in each of the primary scans with respect to the primary scan line, and to prevent the oozing and unevenness of liquid from occurring. Herein, the ejection rate means a rate of an area ejected in a predetermined area of using a first nozzle to the predetermined area, where a nozzle column including the first nozzle ejected.

The technical spirit of the invention can be implemented not only by a concrete liquid ejection control device but also as a liquid ejection control method. That is, the invention can be specified as a method having processes corresponding to all units of the above-mentioned liquid ejection control device. In the case in which the liquid ejection control device reads a program and executes all of the above units, the technical spirit of the invention can be concreted as a program which executes functions corresponding to all of the above units and also as various recording media which records the program. The liquid ejection control device of the invention may exist dispersed in a plurality of devices as well as exist in the form of a single device. For example, all of the units provided in the liquid ejection control device may be dispersed in the printer driver executed in a personal computer and a printer. Further, all of the units of the liquid ejection control device of the invention can be included in a printing device, such as a printer.

### BRIEF DESCRIPTION OF THE DRAWINGS

The invention will be described with reference to the accompanying drawings, wherein like numbers reference like elements.

FIG. 1 is a block diagram illustrating hardware configuration of a liquid ejection control device.

FIG. 2 is a block diagram illustrating software configuration of the liquid ejection control device.

FIG. 3 is a block diagram illustrating an overall structure of a printer.

FIG. 4 is an explanatory view illustrating a relationship between a primary scan and a subordinate scan.

FIG. 5 is an explanatory view illustrating a positional relationship between a discharge head and print paper.

FIG. 6 is a view illustrating an arrangement rule of ink dots.

FIG. 7 is a flowchart illustrating the flow of print control processing.

FIG. 8 is a flowchart illustrating the flow of rasterizing processing.

FIG. 9 is a schematic view illustrating nozzle discharge data.

FIG. 10 is a view illustrating duty.

FIG. 11 is a schematic view illustrating an ink-dot forming operation.

FIG. 12 is a view illustrating duty.

FIG. 13 is a view illustrating duty.

FIG. 14 is a view illustrating a structure of a liquid ejection control device according to a modification.

FIG. 15 is a view illustrating a discharge characteristic database according to the modification.

FIG. 16 is a view illustrating duty according to the modification.

### DESCRIPTION OF EXEMPLARY EMBODIMENTS

Embodiments of the invention will be described in the following order:
A. Structure of device
B. Print control processing
C. Print result
D. Combination of a plurality of inks
E. Modification

### A. Structure of Device

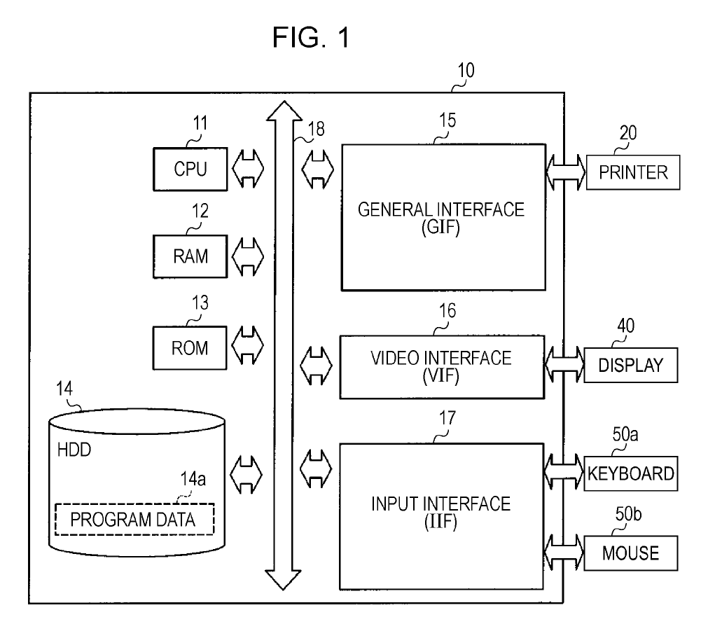

FIG. 1 schematically shows hardware configuration of a liquid ejection control device according to one embodiment of the invention. In FIG. 1, the liquid ejection control device is primarily constituted as a computer 10. The computer 10 includes a CPU 11, a RAM 12, a ROM 13, a hard disk drive (HDD) 14, a general interface (GIF) 15, a video interface (VIF) 16, an input interface (IIF) 17, and a bus 18. The bus 18 enables data communication to be performed between respective members 11 to 17 which constitute the computer 10, and communication is controlled by a chip set (not shown). The HDD 14 stores program data 14a for executing various programs including an operating system (OS). The program data 14a is developed in the RAM 12 and the CPU 11 executes computing based on the program data 14a. The GIF 15 provides interface based on, for example, USB standard so that an external printer 20 is connected to the computer 10. The VIF 16 enables the computer 10 to be connected to an external display unit 40, and provides interface for displaying an image on the display unit 40. The IIF 17 enables the computer 10 to be connected to external devices including a keyboard 50a and a mouse 50b and provides interface for enabling the computer 10 to acquire input signals from the keyboard 50a and the mouse 50b.

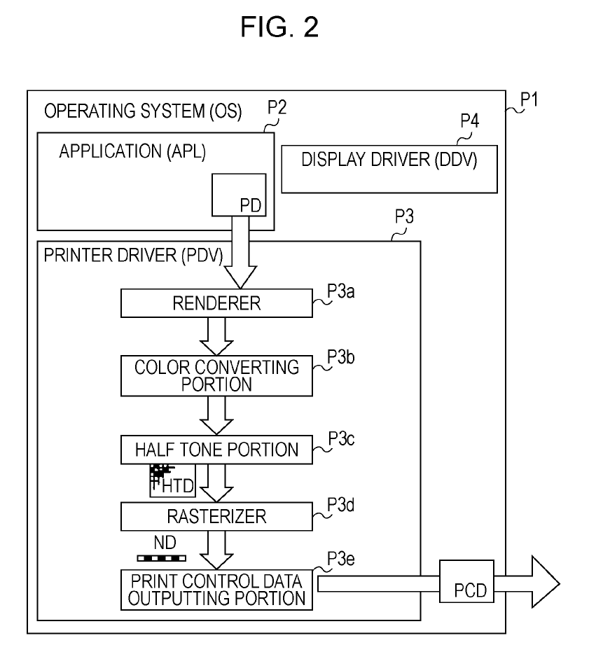

FIG. 2 schematically shows software configuration of the program executed by the computer 10. As shown in FIG. 2, in the computer 10, the OS P1, an application program P2, a printer driver P3 (liquid ejection control program), and a display driver P4 are executed. The OS P1 provides API which can be commonly used by various programs. The application program P2 is an application program for producing print data PD and produces the print data PD according to input operation performed using the keyboard 50a and the mouse 50b. The printer driver P3 is composed of a renderer P3a, a color conversion portion P3b, a half tone portion P3c, a rasterizer P3d (ejection control unit), and a print control data output portion P3e. The renderer P3a performs processing of drawing print image data on the basis of the print data PD. The color conversion portion P3b acquires print image data, and converts the print image data to data in an ink amount space which is used by the printer 20. The half tone portion P3c acquires print image data which is color-converted and produces half tone data HTD by performing half tone processing with respect to the print image data. The rasterizer P3d acquires the half tone data HTD and produces nozzle discharge data ND for each primary scan by analyzing the half tone data HTD. The print control data output portion P3e produces the print control data PCD on the basis of the nozzle discharge data ND and outputs it to the printer 20. The print control processing executed by the printer driver P3 will be described below in more detail.

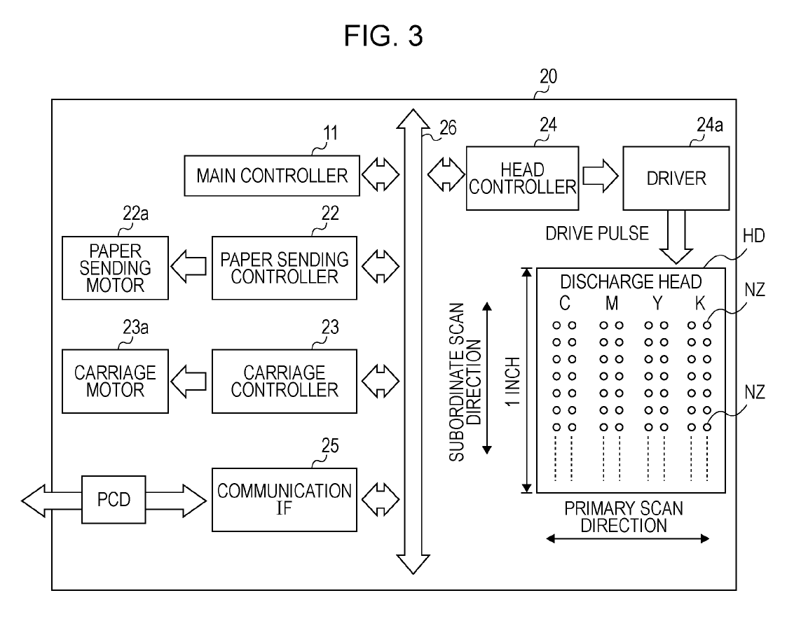

FIG. 3 shows a schematic structure of the printer 20 according to this embodiment. As shown in FIG. 3, the printer 20 is composed of a main controller 21, a paper sending controller 22, a paper sending motor 22a, a carriage controller 23, a carriage motor 23a, a head controller 24, a driver 24a, a communication interface (IF) 25, a bus 26, and a print head HD. All of respective members of the printer 20 perform data communication via the bus 26. The communication IF 25 receives print control data PCD sent from the computer 10, and sends it to the main controller 21. The main controller 21 acquires the print control data PCD and controls the paper sending controller 22, the carriage controller 23, and the head controller 24 on the basis of the print control data PCD.

The paper sending controller 22 controls drive amount and drive timing of the paper sending motor 22a on the basis of the print control data PCD. The paper sending motor 22a drives the paper sending roller which transfers print paper P serving as an ejection object medium and the print paper P is sent (subordinately scanned) when the paper sending motor 22a starts. The carriage controller 23 controls drive amount and drive timing of the carriage motor 23a on the basis of the print control data PCD. The carriage motor 23a makes the carriage equipped with the print head HD reciprocate (perform a primary scan) in a direction which almost perpendicularly intersects a subordinate scan direction in which the print paper P is subordinately scanned.

The discharge head HD of this embodiment is provided with nozzle columns in which discharge nozzles NZ of CMYK colors are arranged in the subordinate scan direction, and columns of the discharge nozzles NZ are arranged in the primary scan direction. The discharge head HD is 1 inch long in the primary scan direction, and each nozzle column includes 360 discharge nozzles NZ which are arranged in the subordinate scan direction at regular pitches. That is, the density of the discharge nozzles NZ of the discharge head HD in the subordinate scan direction is 360 dpi. Each discharge nozzle NZ links with an ink chamber to which ink is supplied. Piezoelectric elements (not shown) which apply mechanical pressure to corresponding ink chambers are provided for respective discharge nozzles NZ.

The head controller 24 makes the driver 24 a produce drive pulses to be applied to the piezoelectric elements of the print head HD on the basis of the print control data PCD. With such a mechanism, a plurality of ink droplets is discharged from the discharge nozzles NZ and the ink droplets strike the print paper P and then are dried, so that a plurality of ink dots is recorded on the print paper P. When the print head HD performs a primary scan once, a plural number of drive pulses is output with respect to the piezoelectric elements and therefore it is possible to form a raster line in the primary scan direction on the print paper P. It is possible to adjust the density of ink dots in the primary scan direction on the print paper P by adjusting an output period of the drive pulse and it is possible to adjust positions of ink dots in the primary scan direction on the print paper P by adjusting the output timing. The output period and output timing of the drive pulse are controlled on the basis of nozzle discharge data ND produced by the rasterizer P3d. In this embodiment, a dual direction printing mechanism in which drive pulses are output when the print head HD performs primary scans in both of a forward direction and a backward direction may be adopted.

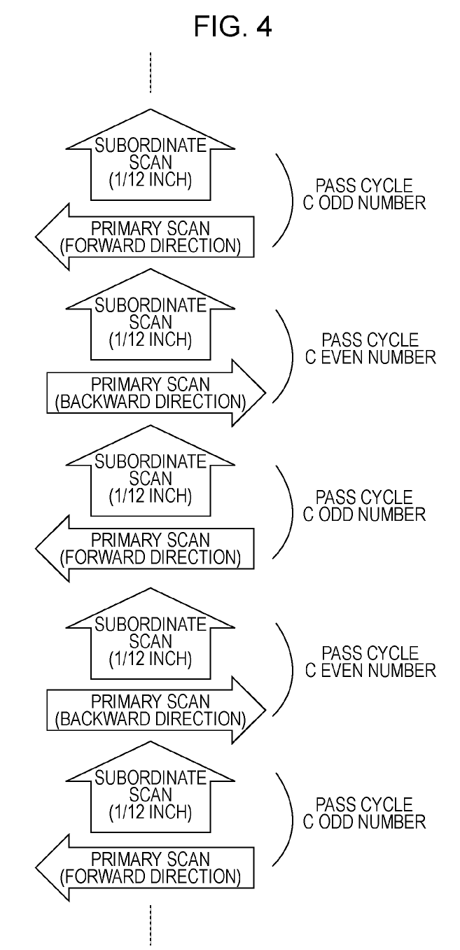

FIG. 4 shows the primary scan operation of the discharge head HD and the subordinate scan operation of the print paper P. In this embodiment, the dual direction printing is performed. That is, the discharge head HD alternately performs the primary scan while discharging the ink from respective discharge nozzles NZ. The paper sending controller 22 makes the print paper P performs the subordinate scan by 1/12 inch whenever the discharge head HD completes the primary scan once. In this manner, it is possible to form a two-dimensional plane image on the print paper P by performing the primary scan and the subordinate scan. A single pass cycle is composed of a single subordinate scan and a single primary scan. In the odd numbered pass cycles, the discharge head HD performs the primary scans in the rightward direction of the paper surface. In the even numbered pass cycles, the discharge head HD performs the primary scans in the leftward direction of the paper surface. The numbers of the pass cycles are referenced with the reference C.

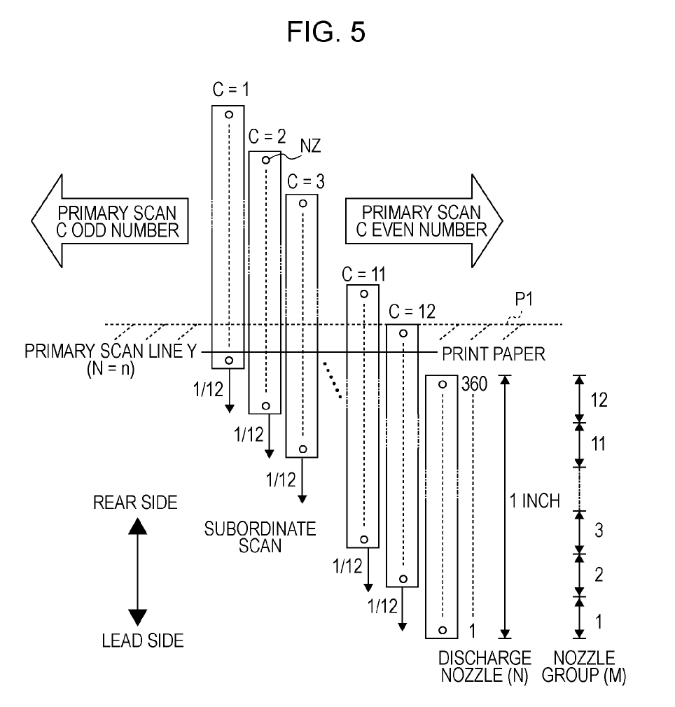

In FIG. 5, relative positional relationship between the discharge head HD and the print paper P is schematically shown. In order to simplify the illustration, only a single nozzle column (a single column of C ink) is shown in the figure. The discharge head HD moves only in the primary scan direction and does not actually move in the subordinate scan direction. However, owing to the relative movement of the print paper P in the subordinate scan direction, the figure shows for convenience's sake such that the discharge head HD seems to move in the subordinate scan direction in the pass cycle of C=1 to 12 while the print paper P is fixed. Since the print paper P subordinately scans the discharge head HD in the subordinate scan direction from the lower side to the upper side of itself, a portion of the discharge head HD at the lower side of the print paper reaches the print paper P first. Accordingly, one side of the discharge head HD at the lower side of the print paper P is referred to as a lead side, and the other side of the discharge head at the upper side of the print paper P is referred to as a rear side. Each of the discharge nozzles has its own nuzzle number. The discharge nozzle NZ at a lead side end of the discharge head is referred to as the first nozzle (N=1), and the discharge nozzle NZ at a rear side end of the discharge head is referred to as the 360th nozzle (N=360). The discharge nozzles NZ are grouped in the unit of 30 nozzles. The foremost group is referred to as the first nozzle group (M=1) and the rearmost group is referred to as the twelfth nozzle group (M=12).

In this embodiment, the paper sending controller 22 makes the print paper P subordinately scan by 1/12 inch whenever the discharge head HD finishes the primary scan once. Accordingly, as shown in the figure, the discharge head HD progresses by 1/12 inch toward the lower side of the paper surface of the print paper P. Accordingly, in the case in which the discharge nozzle NZ belonging to the (M=m)-th nozzle group is in charge of formation of an ink dot with respect to a position on the print paper P in the subordinate scan direction in a certain pass cycle, the discharge nozzle NZ belonging to the (M=m+1)-th nozzle group becomes in charge of formation of an ink dot with respect to the position in the next pass cycle. In more detail, in the case in which the n-th discharge nozzle NZ is in charge of formation of an ink dot with respect to a primary scan line L in the subordinate scan direction on the print paper P in a certain pass cycle, the (N=n+30)-th discharge nozzle NZ is in charge of formation of an ink dot with respect to the primary scan line in the next pass cycle. Further, with respect to the primary scan line L of which an ink dot is formed by the n-th (n<30) discharge nozzle NZ in the first pass cycle (C=1), the discharge nozzle NZ which forms an ink dot in a certain pass cycle C (C≦12) can be referred to as the (N=n+30×(C−1))-th discharge nozzle NZ.

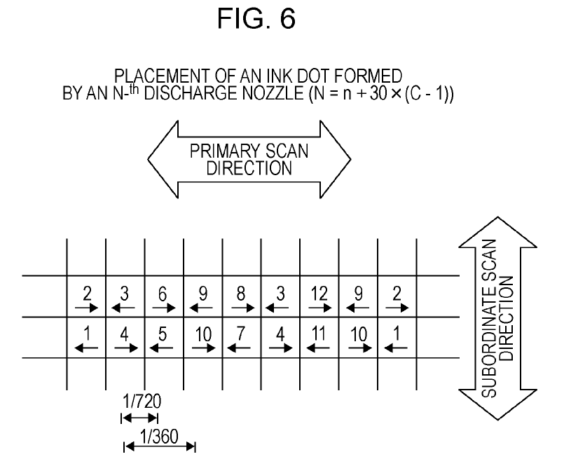

FIG. 6 shows the arrangement rule of ink dots (recording pixels) according to this embodiment. FIG. 6 schematically shows the detailed position of the (N==n+30×(C−1))-th discharge nozzle for forming an ink dot on the primary scan line L of the print paper P in each of the pass cycles. The number of each of the pass cycles and an arrow which indicates reciprocating movement in each of the pass cycles are shown in association with the position for formation of the ink dot. Basically, the positions on the print paper P where the ink dots are formed by the (N=n+30×(C−1))-th discharge nozzle are almost the same. However, in this embodiment, the formed positions of the ink dots are slightly misaligned so that the ink dots are formed in the recording density of 720×720 dpi. Here, the paper sending controller 22 adjusts the paper sending amount in a manner such that the positions of the ink dots formed in the first, second, third, fourth, fifth, and sixth (C=1, 2, 3, 4, 5, and 6) pass cycles and the positions of the ink dots formed in the seventh, eighth, ninth, tenth, eleventh, and twelfth (C=7, 8, 9, 10, 11, and 12) pass cycles are shifted from each other, respectively by the half of a pitch of the discharge nozzles NZ in the subordinate scan direction.

With this control, it is possible to realize the density of 720 dpi of the ink dots in the subordinate scan direction. Further, the head controller 24 adjust the discharge timing in a manner such that the positions of the ink dots formed in the first and seventh (C=1, 7) pass cycles, the positions of the ink dots formed in the second and eighth (C=2, 8) pass cycles, the positions of the ink dots formed in the third and ninth (C=3, 9) pass cycles, the positions of the ink dots formed in the fourth and tenth (C=4, 10) pass cycles, the positions of the ink dots formed in the fifth and eleventh (C=5, 11) pass cycles, and the positions of the ink dots formed in the sixth and twelfth (C=6, 12) pass cycles are shifted from respective previously formed ink dots by 1/720 inch in the primary scan direction. Since the discharge is repeated at every periodic discharge time in a single primary scan, the recording density of the ink dots formed in each of the pass cycles in the primary scan direction becomes 360 dpi and therefore the recording density formed in the whole pass cycles in the primary scan direction becomes 720 dpi. The above-mentioned arrangement rule is applied to the entire area in which the ink dots can be formed. By specifying a certain position on the print paper P, it is possible to specify the pass cycle, the discharge nozzle NZ, and the discharge timing for forming an ink dot at the specified position. In this embodiment, with such a premise of the arrangement rule of the ink dots, the following print control processing is performed.

### B. Print Control Processing

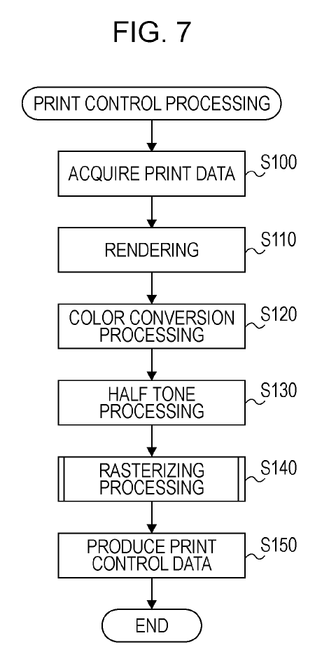

FIG. 7 shows the flow of print control processing executed by the printer driver P3. In Step S100, the renderer 3a acquires print data PD produced by the application program P2. For example, text data and a draw command are acquired as the print data PD. In Step S110, the renderer P3a produces print image data composed of a plurality of pixels having color information of an RGB color space by performing drawing on the basis of the print data PD. In Step S120, the color conversion portion P3b acquires the print image data which is drawn and converts it to print image data in which a color of each pixel is expressed in an ink amount color space of CMYK inks which are used by the printer 20. At this time, a color conversion profile which specifies the correspondence relationship between the RGB color space and the ink amount color space is used. In Step S130, the half tone portion P3c acquires the print image data of the ink amount color space and performs half tone processing by a dither method and an error diffusion method with respect to the print image data. With this processing, half tone data HTD which instructs whether to discharge ink for each pixel is produced for each of inks. In Step S140, the rasterizer P3d executes the rasterizing processing on the basis of the half tone data HTD and therefore produces the nozzle discharge data ND.

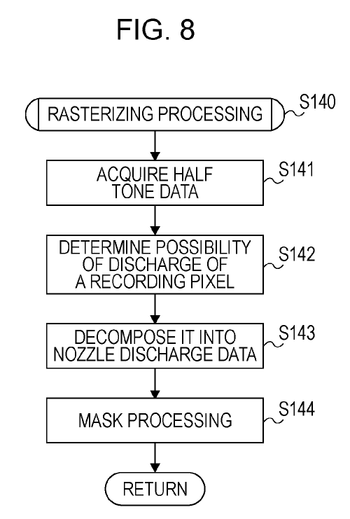

FIG. 8 shows the detailed flow of the rasterizing processing. With reference to FIG. 8, the half tone data HTD for C ink is input to the rasterizer P3d (Step S141). In the half tone data HTD, each position on the print paper P is designated with each pixel in the pixel density of 360×360 dpi and whether to discharge the C ink or not with respect to each pixel is instructed. It is determined whether to form each ink dot by confronting the arrangement rule shown in FIG. 6 of the ink dots with the position of each pixel of the half tone data HTD (Step S142). In the above-mentioned manner, when it is determined whether to form ink dots of 720×720 dpi shown in FIG. 6, the data is analyzed into nozzle discharge data ND which specifies discharge characteristics of all of the discharge nozzles NZ in each of primary scans on the basis of the arrangement rule of FIG. 6 (Step S143).

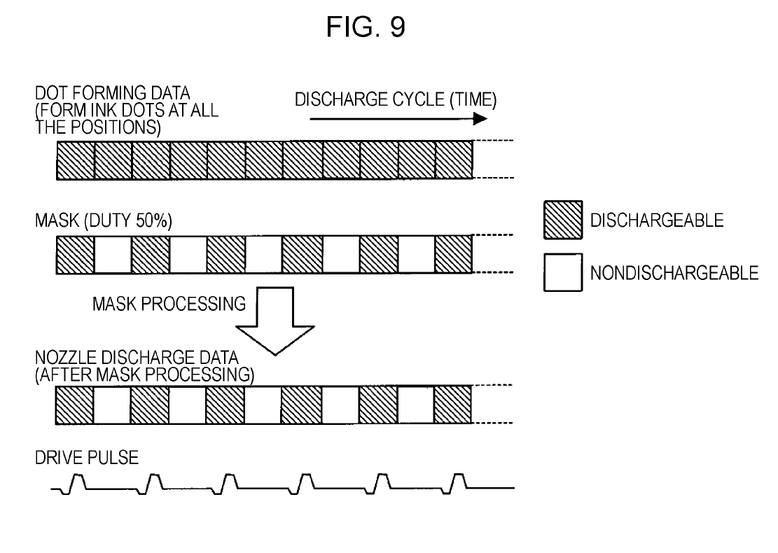

FIG. 9 schematically shows the operation of producing the nozzle discharge data ND with respect to a certain discharge nozzle NZ in a certain primary scan. With reference to FIG. 9, with respect to all of the ink-dischargable positions, the dot forming data, which shows positions where ink dots must be formed in a certain primary scan, is input on the basis of the half tone data HTD. In FIG. 9, a mask is conceptually shown. The discharge limitation is applied in a manner such that only some discharge nozzles of the ink dots specified by the dot forming data actually discharge ink according to a ratio of the duty by applying the mask to the dot forming data. With this control, the nozzle discharge data ND which instructs whether certain discharge nozzles NZ to discharge ink in a certain primary scan is produced. If the discharge limitation is lopsided in the primary scan direction, lopsided ink concentration in the primary scan direction is also shown. Accordingly, it is desirable that the mask which is uniform in the primary scan direction be used. As schematically shown in FIG. 9, in the printer 20, it can be said that the drive pulses output to the piezoelectric elements are generated on the basis of the nozzle discharge data ND obtained after the mask processing. The duty is prescribed for each of the discharge nozzles NZ. That is, the duty is prescribed according to the positions of the discharge nozzles NZ in the subordinate scan direction.

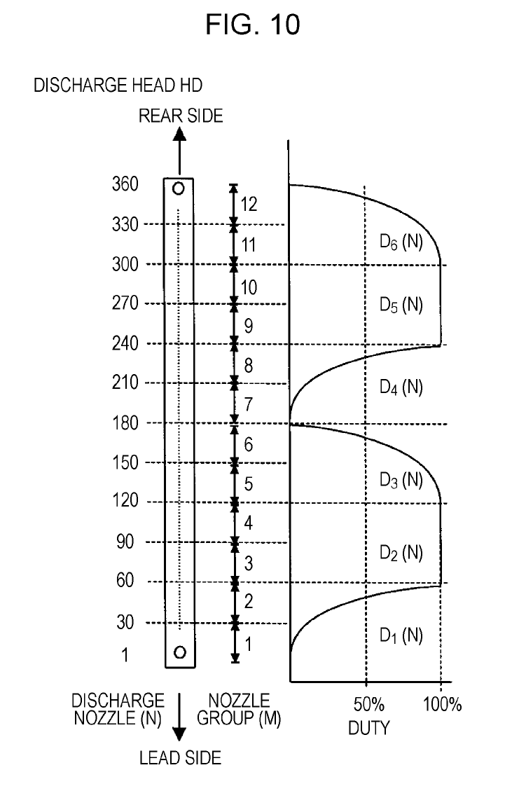

FIG. 10 shows the change of the duty prescribed according to the positions of the discharge nozzles NZ in the subordinate scan direction.

The duty is defined in a manner such that different forms of change are shown for the first to sixtieth discharge nozzles NZ (corresponding to nozzle groups M=1 and 2) disposed at the lead side, the sixtieth to one hundred twentieth discharge nozzles NZ (corresponding to nozzle groups M=3 and 4), the one hundred twentieth to one hundred eightieth discharge nozzles NZ (corresponding to nozzle groups M=5 and 6), the one hundred eightieth to two hundreds fortieth discharge nozzles NZ (corresponding to nozzle groups M=7 and 8), the two hundreds fortieth to three hundredth discharge nozzles NZ (corresponding to nozzle groups M=9 and 10), and the three hundredth to three hundreds sixtieth discharge nozzles NZ (nozzle groups M=11 and 12). When this duty is expressed by an equation, the equation may become Equation 1.

$$\begin{matrix}Equation 1 & \\ \begin{matrix}{D}_{1} ( N ) = \frac{100}{{60}^{2}} {N}^{2} & ( 1 \leq N < 60 ) \\ {D}_{2} ( N ) = 100 & ( 60 \leq N < 120 ) \\ {D}_{3} ( N ) = - \frac{100}{{60}^{2}} {( N - 120 )}^{2} + 100 & ( 120 \leq N < 180 ) \\ {D}_{4} ( N ) = \frac{100}{{60}^{2}} {( N - 180 )}^{2} & ( 180 \leq N < 240 ) \\ {D}_{5} ( N ) = 100 & ( 240 \leq N < 300 ) \\ {D}_{6} ( N ) = - \frac{100}{{60}^{2}} {( N - 300 )}^{2} + 100 & ( 300 \leq N \leq 360 )\end{matrix} & ( 1 )\end{matrix}$$

In Equation 1, D₁(N), D₂(N), D₃(N), D₄(N), D₅(N), and D₆(N) show the duties (%) of the respective discharge nozzles NZ, and are expressed in the function of the nozzle number N. In the discharge nozzles NZ of the nozzle groups (M=1, 2, 7, and 8), the duties D₁(N) and D₄(N) are expressed in the quadratic function of monotone increasing in which the slope becomes gradually stiff, and the duties D₃(N) and D₆(N) of the discharge nozzles NZ of the nozzle groups (M=5, 6, 11, and 12) are expressed in the quadratic function of monotone decreasing in which the slope becomes gradually stiff. When the duties are expressed in the graph form, the duty D₁(n) and the duty D₃(N) are line-symmetric to each other with respect to a straight line which indicates a constant concentration and also the duty D₄(n) and the duty D₆(N) are also line-symmetric. That is, the duty D₁(n) and the duty D₃(N) are in the complementary relationship so that the sum of the duty D₁(n) obtained when a certain n (0<n≦60) is inputted as N of the duty D₁(N) and the duty D₃(n+120) obtained when (n+120) is inputted as N of the duty D₃(N) is always 100%. In similar manner, the duty D₄(n) and the duty D₆(N) are in the complementary relationship so that the sum of the duty D₄(n) obtained when a certain n (0<n≦60) is inputed as N of the duty D₄(N) and the duty D₆(n+120) obtained when (n+120) is inputted as N of the duty D₆(N) is always 100%. On the other hand, with respect to a line in a direction which almost perpendicularly intersects the straight line, the duty D₁(N) and the duty D₃(N) are asymmetric and the duty D₄(N) and the duty D₆(N) are also asymmetric. That is, the duty for a nozzle is asymmetric with respect to the nozzle position. As for the discharge nozzles NZ of the nozzle groups (M=1 and 4), the duties of the discharge nozzles NZ become D₁(n) and D₄(n) of subsequent to the rising from the top of the quadratic curve and therefore it is possible to greatly suppress the discharge rate.

In the discharge nozzles NZ of the nozzle groups (M=3, 4, 9, and 10), since the duty D₂(N)=D₅(N)=100, the mask processing is not actually performed with respect to the nozzle discharge data ND. Further, in the nozzle groups (M=2 and 5) the duties are maximum and uniform. That is, in this embodiment, the nozzles of which the duties are the maximum and uniform are dispersed into two nozzle groups. In this embodiment, the nozzle discharge data ND which is in consideration of the duties is generated by performing the duty limitation with respect to the nozzle discharge data ND in each of the primary scans. Here, the description is made in relation with only the C ink, but the rasterizing processing is also performed with respect to other MYK inks too. In such a manner, if the nozzle discharge data ND for each of the discharge nozzles NZ in each of the primary scans is generated, the rasterizing processing ends. In Step S150 of FIG. 7, the print control data output portion P3e produces the print control data PCD by adding data for the paper sending controller 22 and the carriage controller 23 to each nozzle discharge data ND. Further, the print control data PCD is output to the printer PCD, and the printing is actually executed by the printer 20. With this control, the primary scans and the subordinate scans shown in FIGS. 4 to 6 are executed in order.

### C. Print Result

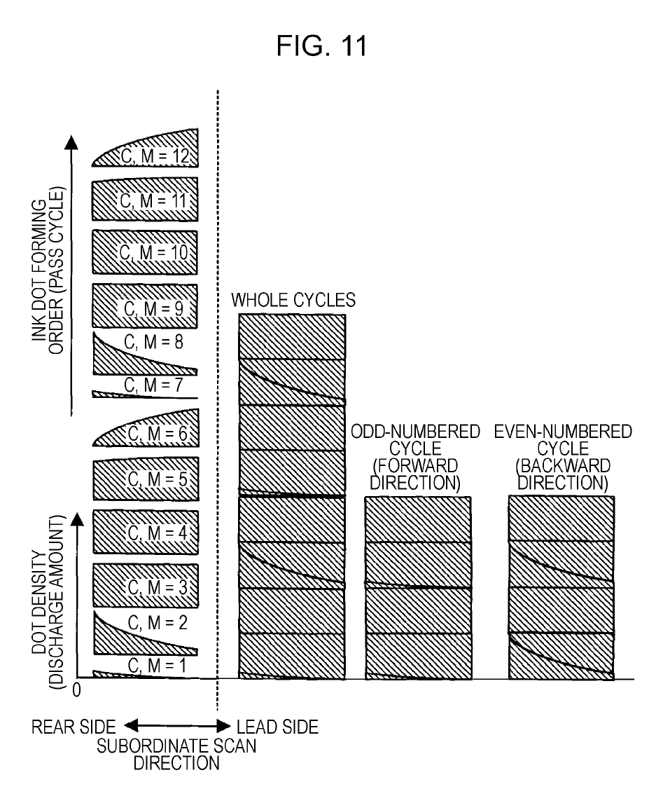

FIG. 11 schematically shows the operation of forming ink dots on the print paper P. FIG. 11 shows the change of density of the ink dots on the print paper P in each of pass cycles when an image in which the half tone result of the C ink is uniform over the entire area of the print paper P (i.e. an image which means the discharge from the entire pixels in the half tone data HTD) is printed. As the mask processing is performed with respect to such an image in Step S144, the density distribution according to the duties D₁(N) to D₆(N) in each of pass cycles comes to be formed. Further, since it can be said that the ink amount discharged for forming each of the ink dots is uniform, it can be said that the distribution of the density corresponds to the distribution of the ink amount which is discharged at each of subordinate scan positions. Since the discharge head HD progresses relative to the print paper P by 1/12 inch during a period of each cycle, the nozzle group which is in charge of formation of ink dots for the primary scan line L at a predetermined position in the subordinate scan direction is shifted toward the rear side group by group. In more detail, the nozzle number N of the discharge nozzle NZ which forms the ink dot for the primary scan line L is incremented by 30. The direction of the primary scan alternates in each of the pass cycles.

According to the duty D₁(N) which prescribes the density of ink dots of the nozzle group (M=1) from which ink reaches the print paper P for the first time, it is possible to suppress the ink amount which is discharged toward the print paper P at the beginning to the minimum by the rising portion which is subsequent to the top of the quadratic curve. With this control, it is possible to suppress oozing and agglomeration of ink at the beginning of formation of ink dots. By maintaining ink droplets at appropriate positions at the beginning of formation of ink dots, it is possible to prevent ink droplets which subsequently strike the print paper from oozing or prevent agglomeration of ink from occurring. Accordingly, when the last printing is finished, it is possible to prevent uneven brightness and concentration from occurring. In this manner, it is possible to control subtle density of ink dots by prescribing the duty in the nonlinear function. In the forward direction pass cycles (C=1, 3, 5, 7, 9, and 11) the odd numbered nozzle groups (M=1, 3, 5, 7, 9, and 11) are in charge of formation of ink dots for the primary scan line L. In the backward direction pass cycles (C=2, 4, 6, 8, 10, and 12), the even numbered nozzle groups (M=2, 4, 6, 8, 10, and 12) are in charge of formation of ink dots for the primary scan line L.

The nozzle groups (M=1 and 2) at the lead side and the nozzle groups (M=5 and 6) are in the complementary relationship so that the sum of the duty D₁(n) obtained when a certain n (0<n≦60) is input as N of the duty D₁(N) corresponding to the nozzle group at the lead side and the duty D₃(n+120) obtained when (n+120) is inputted as N of the duty D₃(N) is always 100%. Accordingly, the discharge amount (density of ink dots) of the nozzle groups (M=1 and 2) in the forward direction pass cycles (C=1 and 2) can be compensated by the discharge amount (density of ink dots) of the nozzle groups (M=5 and 6) in the forward direction pass cycles (C=5 and 6). That is, although the density of ink dots formed by the nozzle groups (M=1 and 2) at the lead side is decreased by the duty D₁(N), the decrease can be compensated by the increase in the density of ink dots formed by the nozzle groups (M=5 and 6). Accordingly, it is possible to suppress the density of ink dots at the beginning of formation of ink dots without the increase in the total pass cycles. In a similar manner, the discharge amount (density of ink dots) of the nozzle groups (M=7 and 8) in the backward pass cycles (C=7 and 8) can be compensated by the discharge amount (density of ink dots) of the nozzle groups (M=11 and 12) in the backward direction pass cycles (C=11 and 12). Accordingly, at any positions in the subordinate scan direction, the density of ink dots is uniform at the time when all of the pass cycles are completed. Since the density of ink dots formed by all of the forward direction pass cycles is equal to the density of ink dots formed by all of the backward direction pass cycles, even if there is the difference in discharge characteristics of the forward and backward directions, it is possible to maintain the uniform density of ink dots.

As described above, the maximum nozzle groups (M=3, 4, 9, 10) in which the duty is the maximum and uniform are dispersed into two parts. That is, the nozzle groups (M=3, 4, 9, and 10) which most strongly influences the print result are placed in a dispersed manner. As described above, since the nozzle groups (M=2 and 5) which most strongly influences the print result do not gather at the same place, it is possible to reduce the negative influence, which is attributable to local defectiveness of the discharge nozzles NZ, on the print result. For example, although the nozzle groups (M is around 3) is in trouble, large amounts of ink can be normally discharged from the nozzle group (M=9) which is spaced apart from the nozzle group (M=3) in the subordinate scan direction in a great distance, and therefore it is possible to reduce the negative influence attributable to the trouble of the nozzles. Further, since it is possible to suppress the discharge amount of the discharge nozzles disposed at a midway position of the subordinate scan direction, it is possible to effectively reduce the influence attributable to the trouble of the discharge nozzle even though the discharge nozzle NZ at the midway position is in trouble.

### D. Combination of a Plurality of Ink Colors

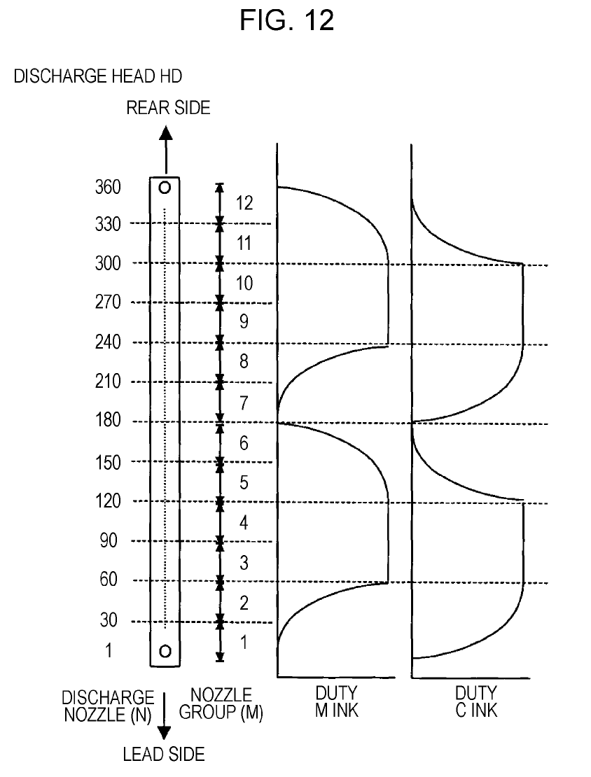

FIG. 12 shows an example of the duty. In FIG. 12, the duties of the discharge nozzles NZ for discharging the C ink and the duties of the discharge nozzles NZ for discharging the M ink are confronted. In the above-mentioned embodiment, only the discharge nozzle NZ for discharging the C ink is exemplified. However, since discharge nozzles NZ for discharging the MYK inks are also installed in an actual practice, the duties for performing the mask processing must be prescribed with respect to these discharge nozzles NZ too. By prescription of the above-mentioned duties, it is possible to prevent oozing and unevenness of ink from occurring. However, since the oozing and unevenness are attributable not only to a single kind of ink but also to the relationship between plural kinds of ink, it is desirable that the duty be set in consideration of a use state of various kinds of ink.

As shown in FIG. 12, the duties of the CM inks of the pair are symmetric with respect to a duty axis. In more detail, the duty of the C ink continuously increases from the beginning of formation of a raster line but the duty of the M ink is low. Conversely, the duty of the M ink decreases but the duty of the C ink is high at the ending of formation of the raster line. In this embodiment, in the case of performing color conversion with respect to the average image data, since there is tendency that the ink amounts of the CM inks are larger than the ink amount of other YK inks, the duties of the CM inks are controlled as shown in FIG. 12. Since there is a tendency that the densities of ink dots of the CM inks are higher than those of other YK inks, in the case in which ink dots of the CM inks simultaneously strike the print paper P, oozing and unevenness of the ink are likely to occur. That is, it is preferable that the ink dots of the CM inks be not simultaneously placed on the print paper in order to prevent the oozing and unevenness of ink from occurring. As shown in FIG. 12, with the control in which the duty of the C ink is maintained high from the beginning of formation of ink dots but the duty of the M ink is low, it is possible to prevent intervention between the CM inks at the beginning of formation of ink dots.

In this embodiment, the CM inks are exemplified as inks of which ink amount is larger than that of other inks, but such inks are not limited to the CM inks. In this embodiment, since the color conversion portion P3b performs color conversion so as to produce the ink amount image data of CMYK inks with reference to the color conversion profile, which ink is set to have relatively large ink amount depends on the color conversion profile. In the average image data, even in the case in which the ink amounts of the CM inks are larger than those of other YK inks, if the image data is monochrome image data, the ink amount of K ink becomes larger than those of other inks. Accordingly, the pair of inks of which the ink amounts are larger than those of other inks may be selected according to print mode (color conversion profile) and image data. In this embodiment, the duty of the C ink having lower fixing characteristic than the M ink is set to be high at the beginning of formation of the raster line, but if there is no big difference between the fixing characteristics of the CM inks, the duty of the M ink may be also set to be high from the beginning of formation of the raster line. The fixing characteristic can be learned by the time needed for the ink dot to strike the print paper P and then to be fixed on the print paper P. Typically, it can be said that the fixing time of the ink becomes longer as the concentration of ink becomes lower because the ink with low concentration contains a larger amount of moisture which must be evaporated so that the color material (mixed material) is anchored. After the color material is anchored on the print paper P, interference with other ink dots is not likely to occur. Accordingly, it is preferable that the ink with a lower concentration be fixed nearly before the middle stage of formation of the raster line, formed by placing a large amount of ink dots on the print paper.

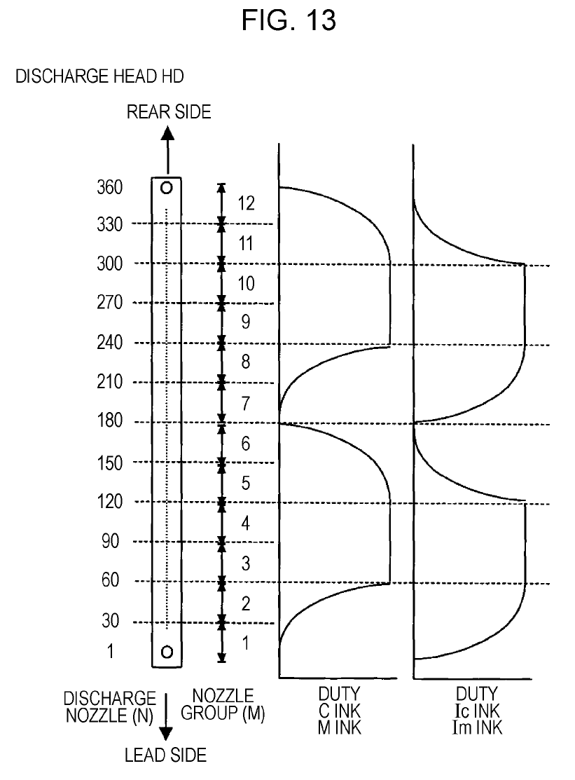

FIG. 13 shows another example of the duty. In this example, the discharge head HD is also provided with discharge nozzles NZ for discharging 1c (light cyan) ink and 1m (light magenta) ink in addition to the discharge nozzles NZ for discharging CM inks. The 1c ink and the 1m ink are prepared by using the same color materials of the CMYK inks, respectively of low concentration. As shown in FIG. 13, the C ink and the 1c ink are in a pair, and the M ink and the 1m ink are in a pair. The duties of inks in the pair are symmetric with respect to the duty axis. In more detail, the duties of the 1c ink and the 1m ink are continuously high from the beginning of formation of the raster line, but the duties of the CM inks are low. Conversely, at the ending of formation of the raster line, the duties of the 1c ink and the 1m ink are low and the duties of the CM inks are high. With this control, it is possible to place the 1c ink and the 1m ink which need longer fixing times than the CM inks on the print paper P at the beginning of formation of the raster line and to allow the 1c ink and the 1m ink to be fixed to some extent before ink dots with a large amount are placed in the middle stage of formation of the raster line. Accordingly, it is possible to prevent oozing and unevenness from occurring at the middle of formation of the raster line.

### E. Modification

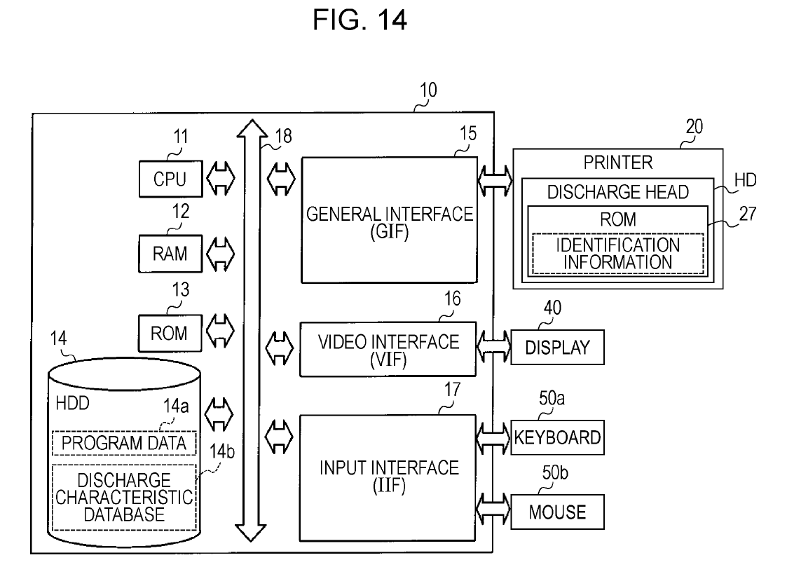

FIG. 14 schematically shows hardware configuration of a liquid ejection control device according to a modification. In FIG. 14, the hardware configuration is almost the same as that of the above-mentioned embodiment (see FIG. 1) except that the HDD 14 stores a discharge characteristic database 14b. Further, the discharge head HD of the printer 20 connected to the computer 10 is provided with a ROM 27. The ROM 27 stores own identification information of the discharge head HD and the computer 10 is adapted to be able to acquire the identification information.

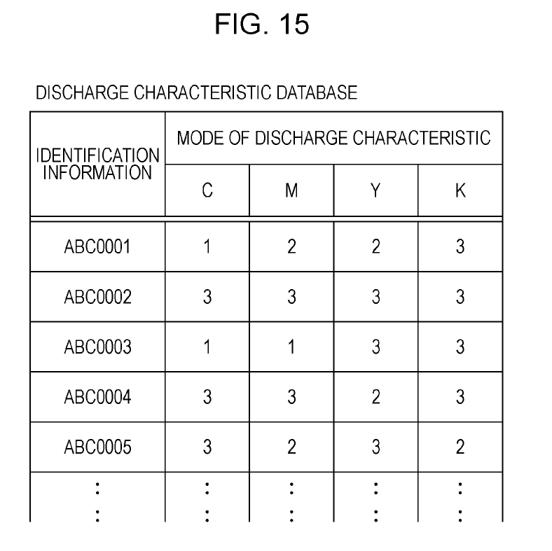

FIG. 15 shows information contained in the discharge characteristic database 14b. As shown in FIG. 15, identification information of each of a plurality of discharge heads HD and discharge characteristics of discharge nozzles NZ for CMYK inks are contained. In this modification, as the discharge characteristic, any of Mode 1, Mode 2, and Mode 3 are recorded with respect to the discharge nozzles NZ of the CMYK inks. Mode 1 means that the discharge amount of the discharge nozzle NZ at a midway position in the subordinate scan direction is unstable, Mode 2 means that the discharge amount of the discharge nozzles at end positions in the subordinate scan direction is unstable, and Mode 3 means that the entire discharge characteristic is good. The discharge nozzles of the CMYK inks will be described. In the rasterizing processing of this modification, the rasterizer P3d executes the mask processing on the basis of the duty depending on the discharge characteristic of Step S145. First of all, the rasterizer P3d acquires the identification information of the discharge head HD mounted in the printer 20 which outputs the print control data PCD from the ROM 27, and acquires the discharge characteristics, which are in association with the identification information, for each of the CMYK inks with reference to the discharge characteristic database 14b.

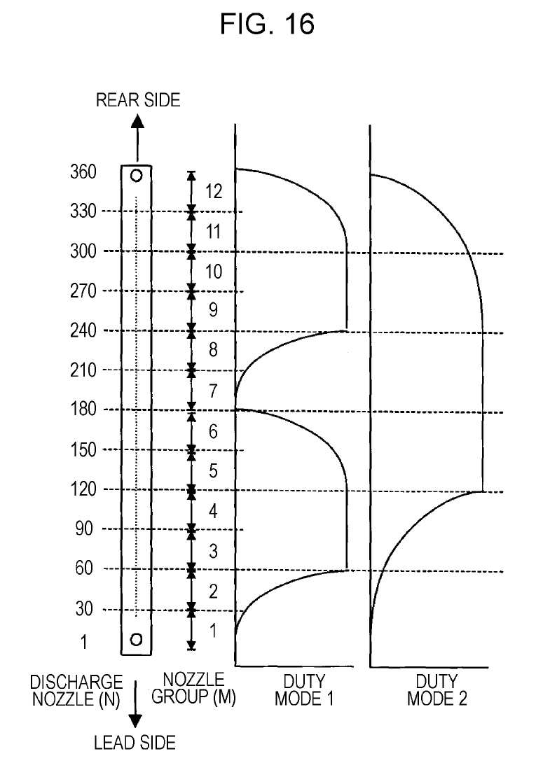

FIG. 16 shows the duties corresponding to the respective discharge characteristics. The rasterizer P3d is preset with the duties corresponding to the discharge characteristics. In Mode 1 in which the discharge amount of the discharge nozzle NZ at a midway position in the subordinate scan direction is unstable, the duty of the discharge nozzle NZ at the midway position is low and an area with the maximum duty is dispersed into two nozzle groups. In Mode 2 in which the discharge amount of the discharge nozzle NZ at end positions in the subordinate scan direction is unstable, the duty of the discharge nozzle NZ at the midway position is the maximum. In Mode 3 in which the entire discharge characteristics are good, either Mode 1 or Mode 2 may be used. Of the discharge characteristics of respective CMYK inks of the same discharge head HD, when Mode 1 competes with Mode 2, the ink with a larger discharge amount in the half tone data HTD becomes a priority and the masks of the duties corresponding to the ink discharge characteristics are applied to the other inks. With this control, it is possible to use the most optimal mask for the ink having the largest discharge amount, and therefore it is possible to obtain good image quality as a whole.

In this manner, it is possible to perform the overlap-type printing by distributing the optimal ink amount according to the characteristic difference of the discharge heads HD. The discharge characteristic database 14b is prepared by checking the discharge characteristics (discharge speed and direction) of ink and eigen frequencies of the piezoelectric elements beforehand when performing a process test of the discharge head HD and the piezoelectric elements of the discharge nozzles NZ. In this modification, the discharge head HD is identified but the discharge characteristic may be determined by a lot or production date. Further, if the discharge characteristics with respect to entire discharge heads HD which are produced, are stored in the discharge characteristic database 14b, the volume of the data becomes vast. Accordingly, the discharge characteristic database 14b is stored in a server on a network, and the computer may use the discharge characteristic by receiving it from the server. In this modification, the identification information of the discharge head HD is acquired when performing rasterizing processing. Alternatively, the identification information may be registered in the printer driver P3 when the printer 20 is connected to the computer for the first time (at the time of setting ports). As a further alternative, the discharge characteristic is directly stored in the ROM 27 of the discharge head HD and then the mask processing may be performed according to the discharge characteristic. In this invention, the maximum nozzle groups having the maximum and uniform duty may be placed avoiding the discharge nozzles NZ of which the discharge characteristics are unstable. Further, three or more maximum nozzle groups may be placed. The number of the maximum nozzle groups can be set.

In the above-mentioned embodiment, the case in which paper sending by 1/12 inch is performed with respect to the discharge head HD which 1 inch long is exemplified. However, the size of the discharge head HD and the amount of paper sending are not limited thereto. Further, the invention is not also limited to the control in which printing of the same position is completed with 12 pass cycles. That is, the invention can be applied to the case in which the printing of the same position can be completed with a number of pass cycles which is more than 12 and also in the case in which the width of paper sending in the subordinate scan direction is different and the printing is performed at different resolutions for each of passes. In this embodiment, the case in which the printer driver P3 executed in the computer executes the rasterizing but the printer 20 may directly perform the rasterizing by itself. The invention is not also limited to the case in which the rasterizing is executed by software but the same processing may be executed by hardware. In the above-mentioned embodiment, an object which forms a print image by discharging liquid is exemplified, but the invention also can be applied to industrial uses, such as surface processing and circuit formation in addition to the formation of the print image as long as the liquid discharge can be controlled.

The entire disclosure of Japanese Patent Application No. 2008-003572, filed Jan. 10, 2008 is incorporated by reference herein.

The entire disclosure of Japanese Patent Application No. 2008-292656, filed Nov. 14, 2008 is incorporated by reference herein.

What is claimed is:

1. A liquid ejection control device which makes an ejection object medium and an ejection nozzle column which ejects liquid relatively scan in a primary scan direction which almost perpendicularly intersects the nozzle ejection column and makes the ejection object medium and the ejection nozzle column relatively scan in a subordinate scan direction which almost perpendicularly intersects the primary scan direction, comprising:
an ejection control unit which controls ejections of ejection nozzles in a manner such that ejection rates of the ejection nozzles vary according to positions of the ejection nozzles in the subordinate scan direction, and the variation is set in a manner such that the ejection nozzles having a maximum ejection rate are dispersed in the subordinate scan line direction, when a rate of an ejection, which is charged by a predetermined ejection nozzle, to a primary scan line at the same position in the subordinate scan direction is called an ejection rate.

2. The liquid ejection control device according to claim 1, wherein there are two or more maximum ejection nozzle groups in each of which the ejection nozzles having the uniform and maximum ejection rate are consecutive in the subordinate scan direction, and which shut in a low ejection nozzle group in which ejection rates of the ejection nozzles are lower than the maximum ejection rate.

3. The liquid ejection control device according to claim 2, wherein there are two or more maximum ejection nozzle groups in each of which the ejection nozzles having the uniform and maximum ejection rate are consecutive in the subordinate scan direction, and wherein the low ejection nozzle group in which ejection rates of the ejection nozzles are lower than the maximum ejection rate and which is shut in by the maximum ejection nozzles groups is disposed at a midway position in the subordinate scan direction in the ejection head.

4. The liquid ejection control device according to claim 1, wherein there are two or more maximum ejection nozzle groups in each of which the ejection nozzles having the uniform and maximum ejection rate are consecutive in the subordinate scan direction, and wherein a low ejection nozzle group in which the ejection rates of the ejection nozzles are lower than the maximum ejection rate and which is shut in by the maximum ejection nozzle groups includes an ejection nozzle having poor stability in an ejection characteristic.

5. The liquid ejection control device according to claim 1, wherein the variation of the ejection rates according to the positions in the subordinate scan direction has a region in which the ejection rates change in a non-linear way.

6. The liquid ejection control device according to claim 1, wherein the ejection control unit acquires characteristic information in which ejection characteristics of the ejection nozzles are stored in association with the ejection nozzles, and controls the ejection rates according to the characteristic information.

7. The liquid ejection control device according to claim 1, wherein the ejection control unit controls to eject liquid with different ejection rates according to kinds of liquid ejected from the ejection nozzles.

8. The liquid ejection control device according to claim 7, wherein in the case in which a liquid, which needs a relatively long time to be fixed on the ejection object medium in comparison with other liquids, is ejected from the ejection nozzle column, the ejection control unit sets a relatively high ejection rate in an initial primary scan in comparison with other liquids.

9. The liquid ejection control device according to claim 7, wherein in the case in which a liquid having a lower concentration than other liquids is ejected from the ejection nozzle column, the ejection control unit sets a relatively high ejection rate for an initial primary scan in comparison with other liquids.

10. The liquid ejection control device according to claim 9, wherein in the case in which a pair of liquids, both having almost the same mixture materials but different concentrations of the mixture materials, is ejected from the ejection nozzle column, in each primary scan with respect to the primary scan line at almost the same position, the ejection control unit controls such that the variations of the ejection rates of the pair of liquids are symmetric, and the ejection rate of a low concentration liquid of the pair of liquids is higher than that of the other liquid in an initial primary scan.

11. The liquid ejection control device according to claim 7, wherein in the case in which a first liquid and a second liquid of which ejection amounts are relatively large in comparison with other liquids are ejected from a first ejection nozzle column and a second ejection nozzle column, respectively, the ejection control unit sets a higher ejection rate for the first liquid in an initial primary scan than for the second liquid.

12. A liquid ejection control method for making an ejection object medium and an ejection nozzle column relatively, simultaneously scan in a primary scan direction which almost perpendicularly intersects the ejection nozzle column and making the ejection object medium and the ejection nozzle column relatively scan in a subordinate scan direction which almost perpendicularly intersects the primary scan direction, when a rate of an ejection, which is charged by a predetermined ejection nozzle and is directed to a primary scan line at the same position in the subordinate scan direction is called an ejection rate, comprising:
controlling the ejection in a manner such that ejection rates of ejection nozzles vary according to positions of the ejection nozzles in the subordinate scan direction and the variation is set in a manner such that the ejection nozzles of which the ejection rates are maximum are dispersed in the subordinate scan direction.

13. A liquid ejection control program which causes a computer to execute a function of making an ejection object medium and an ejection nozzle column relatively, simultaneously scan in a primary scan direction which almost perpendicularly intersects the ejection nozzle column and making the ejection object medium and the ejection nozzle column relatively scan in a subordinate scan direction which almost perpendicularly intersects the primary scan direction, when a rate of an ejection, when a rate of an ejection, which is charged by a predetermined ejection nozzle and is directed to a primary scan line at the same position in the subordinate scan direction is called an ejection rate, wherein a control is performed in a manner such that ejection rates of ejection nozzles vary according to positions of the ejection nozzles in the subordinate scan direction and the variation is set in a manner such that the ejection nozzles of which the ejection rates are maximum are dispersed in the subordinate scan direction.
